(19) United States
(12) Patent Application Publication
(10) Pub. No.: US 2014/0215360 A1
(43) Pub. Date: Jul. 31, 2014

(54) SYSTEMS AND METHODS FOR ANIMATED CLIP GENERATION

(71) Applicant: Quadmanage Ltd., RaAnana (IL)

(72) Inventor: Yoav DEGANI, Tel-Aviv (IL)

(73) Assignee: Quadmanage Ltd., RaAnana (IL)

(21) Appl. No.: 14/165,778

(22) Filed: Jan. 28, 2014

Related U.S. Application Data
(60) Provisional application No. 61/757,302, filed on Jan. 28, 2013.

(51) Int. Cl. H04L 29/06; G06F 3/0481

(52) U.S. Cl. CPC H04L 65/403; G06F 3/0481
USPC 715/753

(57) ABSTRACT

Systems, methods and computer readable products are provided for facilitating a visual session between two or more parties. One or more intention indications are received at a server computer from a client communications device of a first party to the visual session. Subsequently, one or more intention indications are received from the client communications device of a second party to the visual session. The one or more intention indications may be used by the server computer in order to retrieve corresponding multimedia objects. Both parties are provided with access to a generated animated clip comprising one or more of the retrieved multimedia objects.

### RELATED APPLICATION

This application claims the benefit of priority under 35 USC 119(e) of U.S. Provisional Patent Application No. 61/757,302 filed Jan. 28, 2013, the contents of which are incorporated herein by reference in their entirety.

### FIELD AND BACKGROUND OF THE INVENTION

The present invention, in some embodiments thereof, relates to visual messaging and, more specifically, but not exclusively, to systems, methods and a computer program product for automatic generation and/or selection of visual messaging objects.

The use of animated video clips as a means for facilitating the proliferation of promotional content is widespread. Multimedia, and more specifically, video, is gradually used in social networks, the movie and game industries. For instance, socially related video data created and posted to websites by end-users such as internet users and bloggers alone per diem, surpasses the terabyte range and is subject to exponential growth.

Many instant messaging (IM) schemes facilitate the communication of human emotions, intentions and idioms in a purely textual form while enriching and personalizing a social experience. By extension, instant messaging (IM) parties have several ways of conveying and sharing feelings in an IM session. For instance, in some applications, an animated emoticon is utilized for conveying human idioms using a repetitive playback of a sequence of images, resembling an animated clip that visually renders feelings.

Resellers interested in expanding their market share and increasing their exposure to potential consumers, quickly recognized the prospective marketing potential of social networks and IM applications. Strategies for profiting from embedding advertisements, for instance, into websites quickly emerged: such promotional content came in a variety of assorted forms including banners and sponsored links.

### SUMMARY

According to some embodiments of the present invention, there is provided a computerized method of managing a visual session using a plurality of multimedia objects, in a computerized system, including:

receiving, using a processor, a plurality of intention indications from a plurality of client terminals of a plurality of parties participating in the visual session, for each the plurality of intention indications;
selecting at least one multimedia object from a database of the plurality of multimedia objects;
forwarding the at least one multimedia object to be presented on at least one of the plurality of client terminals;
generating the visual session from the at least one of multimedia object;
storing the visual session; and
providing an access to the visual session to the plurality of parties from the plurality of client terminals.

Optionally, wherein the plurality of intention indications include a plurality of text segments, each of the plurality of text segments is extracted from a text messaging interface which is presented on one of the plurality of client terminals to one of the plurality of parties.

Optionally, wherein the plurality of intention indications include a plurality of graphical symbols, each of the plurality of graphical symbols is selected from a palette of graphical symbols which is presented on one of the plurality of client terminals to one of the plurality of parties.

Optionally, further including:

dynamically embedding, at least one of a plurality of candidate advertisements into a plurality of segments in the at least one multimedia object.

Optionally, wherein the plurality of text segments are subject to content analysis, wherein the content analysis identifies a plurality of intention indications.

Optionally, wherein the plurality of graphical symbols are subject to content analysis, wherein the content analysis identifies a plurality of intention indications.

Optionally, wherein the content analysis includes at least one of semantic, morphological and syntactic analysis thereby generating a plurality of text classifications and a sequence of morphemes, the plurality of text classifications and the sequence of morphemes are used for identifying the plurality of intention indications.

Optionally, wherein the content analysis includes at least one of image analysis and motion analysis thereby generating a plurality of image and motion classifications, the plurality of image and motion classifications used for identifying the plurality of intention indications.

According to some embodiments of the present invention, there is provided a system for managing a visual session using a plurality of multimedia objects, including:

a network interface which receives a plurality of intention indications from a plurality of client terminals of a plurality of parties participating in a plurality of iterations of a visual session, each of the plurality of intention indications is received during another of the plurality of iterations;
a multimedia object database which stores a plurality of multimedia objects;
a processor; and
an animated clip service which uses the processor during each of the plurality of iterations to match at least one of the plurality of multimedia objects to one of the plurality of intention indications and to forward the at least one of the plurality of multimedia objects to be presented on at least one of the plurality of client terminals during the visual session.

Optionally, wherein the animated clip service is configured to:

receive a message containing a plurality of intention indications from a plurality of client terminals of a plurality of parties across the network interface;
analyze the plurality of intention indications using a media content analysis unit;
select at least one multimedia object from a plurality of first entries in the multimedia object database using a multimedia object analysis unit; and
in response to the selecting, using a visual session generation unit to generate a respective visual session, thereby allowing each of a plurality of parties access to an application running on each of the client terminals, wherein the application causes a user interface to be displayed on a display of the plurality of client terminals in response to accessing the visual session.

Optionally, wherein the multimedia object database is communicatively coupled to the animated clip service, wherein the multimedia object database storing the plurality of first entries denoting a plurality of multimedia objects, a plurality of second entries denoting a plurality of meta-data, a plurality of third entries denoting a plurality of visual sessions and a plurality of forth entries denoting a plurality of parties.

According to some embodiments of the present invention, there is provided a method for displaying a visual session on a client terminal used by a party, the method including:

providing a party access to a visual session generated by an animated clip service;
initiating presentation of a graphical user interface (GUI) on the client terminal;
wherein the graphical user interface includes at least;
a first area displaying a palette including at least one selectable graphical symbol;
a second area displaying at least one text input;
a third area displaying a button which when clicked, delegates at least one of the at least one text input and the at least one selectable graphical symbol to the animated clip service; and
a forth area displaying the visual session.

Optionally, further including:

simultaneously displaying information in the first area, the second area, the third area and the forth area of the graphical user interface.

According to some embodiments of the present invention, there is provided a computer program product including a non-transitory computer usable storage medium having computer readable program code embodied in the medium for managing a visual session using a plurality of multimedia objects, the computer program product including:

first computer readable program code means for enabling a processor to receiving, from a plurality of client terminals of a plurality of parties participating in the visual session a plurality of intention indications;
for each the plurality of intention indications, second computer readable program code means for enabling a processor to;
selecting at least one multimedia object from a database of a plurality of multimedia objects;
forwarding the at least one multimedia object to be presented on at least one client terminal from the plurality of client terminals;
third computer readable program code means for enabling a processor to generating and managing a visual session from the at least one multimedia object;
forth computer readable program code means for enabling a processor to storing the visual session; and
fifth computer readable program code means for enabling a processor to providing an access to the visual session to the plurality of parties from the plurality of client terminals.

According to some embodiments of the present invention, there is provided a computerized method of storing multimedia objects, in a computerized database system, the method including:

storing, using a processor, a plurality of first entries denoting a plurality of multimedia objects, a plurality of second entries denoting a plurality of meta-data attributes, a plurality of third entries denoting a plurality of visual sessions and a plurality of forth entries denoting a plurality of parties.

Optionally, further including :

receiving at least one intention indication identification;
retrieving a plurality of multimedia objects matching the at least one intention indication identification;
wherein each entry of the plurality of first entries includes at least one of multimedia object identification, date, binary data, type, size;
wherein each entry of the plurality of second entries includes at least one of meta-data identification, date, meta-data attributes, object identification;
wherein each entry of the plurality of third entries includes at least one of visual session identification, date, binary data, type, size, user identification, multimedia identification; and
wherein each entry of the plurality of forth entries includes at least one of party identification, name, location, device type, date.

According to some embodiments of the present invention, there is provided a computerized method of dynamically suggesting multimedia objects in a client terminal of a party, including:

providing a database including a plurality of multimedia objects each associated with at least one of a plurality of candidate keywords;
receiving textual content of a message, the textual content is typed in a message editor by the party using the client terminal before the message is sent to at least one recipient;
identifying, using a processor, a match between at least one keyword in the textual content and a group from the plurality of candidate keywords, the group is associated with at least one of the plurality of multimedia objects;
presenting an indication representing the match on a graphical user interface of the message editor; and
selecting by the party to send the at least one associated animated video clip to the at least one recipient.

Optionally, further including transmitting the at least one animated multimedia object in response to the selection.

Optionally, wherein the indication includes at least one selectable icon, the computerized method further including;

identifying a selection of the at least one selectable icon by the party; and
transmitting the at least one multimedia object in response to the party selection.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a high level block diagram of an exemplary communications system, according to some embodiments of the present invention;

FIG. 2 is another high level block diagram of an exemplary communications system, according to some embodiments of the present invention;

FIG. 3 is a detailed block diagram of an exemplary communications system, according to some embodiments of the present invention;

FIG. 4 is a flowchart illustrating a method of generating and managing an exemplary visual session, according to some embodiments of the present invention;

FIG. 5 is a flowchart illustrating a method for associating promotional content, according to some embodiments of the present invention;

FIG. 6 is a time-lagged flowchart illustrating an exemplary sequence of events occurring during a creation of a visual session, using a computer, between a plurality of parties, according to some embodiments of the present invention;

FIG. 7 is an exemplary entity relationship diagram (ERD) of a multimedia object repository, according to some embodiments of the present invention;

FIG. 8 is a diagram of an exemplary graphical user interface (GUI) of a visual messaging application executing on a processor of a client terminal, according to some embodiments of the present invention;

FIG. 9 is an illustration, describing from the perspective of a party, an exemplary generation process of multiple visual sessions with multiple parties, according to some embodiments of the present invention; and

FIG. 10 is an illustration, describing from the perspective of a party, method of dynamically suggesting animated clips to a party.

### DESCRIPTION OF SPECIFIC EMBODIMENTS OF THE INVENTION

The present invention, in some embodiments thereof, relates to visual messaging and, more specifically, but not exclusively, to systems, methods and a computer program product for automatic generation and/or selection of visual messaging objects.

As used herein, the term visual session refers to a form of visual communications between at least two parties providing inputs comprising one or more intention indications which are processed by, for instance, a computerized analysis system.

In some embodiments of the present invention, the systems, computer program product and methods dynamically generate and manage the visual session by combining multimedia objects, which are selected according to one or more intention indications of at least two separate parties.

As used herein, the term intention indication refers to any text and/or graphical symbol representing, in whole or in part, one or more human intentions. For instance, a textual intention indication may include, but is not limited to, a text contained in a short message service (SMS) message, a text typed by a party during an IM session and/or any other type of textual message. And a graphical intention indication may include, but is not limited to, an emoticon.

It should be noted intention indications may be also calculated from analyzing one or more sentiments found in the text and/or in the graphical symbol. Each sentiment may either have negative or positive association representing negative or positive human emotions respectively.

As used herein, the term multimedia object refers to any type of video that encompasses typical video content. For instance, video content may include, but is not limited to a sequence of video frames, an animated sequence of images, an animated sprite, an animated text and/or an animated audio.

The selection of the multimedia objects may be based on the analysis of the intention indications as well as other information pertaining to the parties, such as the client terminal types used by parties, the preferences of the parties, the locations of the parties, the hobbies of the parties, the demographic properties of the parties and/or the like.

The analysis of intention indications is conducted by an animated clip service running on a central unit, such as server computer, or a system equipped with memory and a processor. Such analysis of intention indications may include, but is not limited to semantic, morphological, syntactic analysis and/or the like.

When a party provides input (i.e. text and/or selected graphical symbols from a palette of graphical symbols), a respective visual session is initiated and optionally managed by the animated clip service. The animated clip service receives the input from one party and forwards a respective, optionally processed, animated clip to one or more other parties. The one or more other parties may in return, also provide input resulting in the repetition of the sequence described above. The analysis of graphical symbols may utilize image processing methods in order to for instance detect objects and subjects depicted in the graphical symbols, or for instance, in case the graphical symbol is animated, the analysis may include motion analysis to detect objects and subjects moving in the animated graphical symbols resulting in motion classifications. The characteristics of the motion such as speed, direction, frequency and/or the like may be utilized in better matching multimedia objects which are relevant to the party.

The analysis of intention indications may result in one or more lists of meta-data attributes associated with each intention indication, including for instance , but not limited to:

I. The time the intention indication was created and analyzed. For instance, a party that is more active during the nights may receive by the animated clip service multimedia objects different from those received by a party who prefers to be more active during the days.
II. A list of morphemes included in a text message. The analysis utilizes an automated morphological analysis to segment and classify the text into a sequence of morphemes and one or more text classifications.
III. The type of the intention indication. For instance, text or graphical symbol. Whether the party has an inclination to using more text rather than graphical symbols, in his communications may affect the selection of the multimedia objects delegated to the party.
IV. A list of genres, categories and/or subjects found in one or more words or morphemes. These may be used to select multimedia objects that reflect the preferences of a party.

As used herein, the term morphological refers to rules of grammar that define the syntactic roles, or parts of speech, that a word may have such as a noun, a verb, an adjective and/or the like.

As used herein, the term a morpheme refers to the smallest meaningful unit in the grammar of a language. For instance, morphological analysis of the English word “Unconsciously” may yield three components, called morphemes. These are the root “conscious” and two affixes, the prefix “un” indicating negation, and one suffixes “ly”.

As used herein, the term client terminal refers to any network connected device including, but not limited to, personal digital assistants (PDAs), tablets, electronic book readers, handheld computers, cellular phones, personal media devices (PMDs), smart-phones, and/or the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

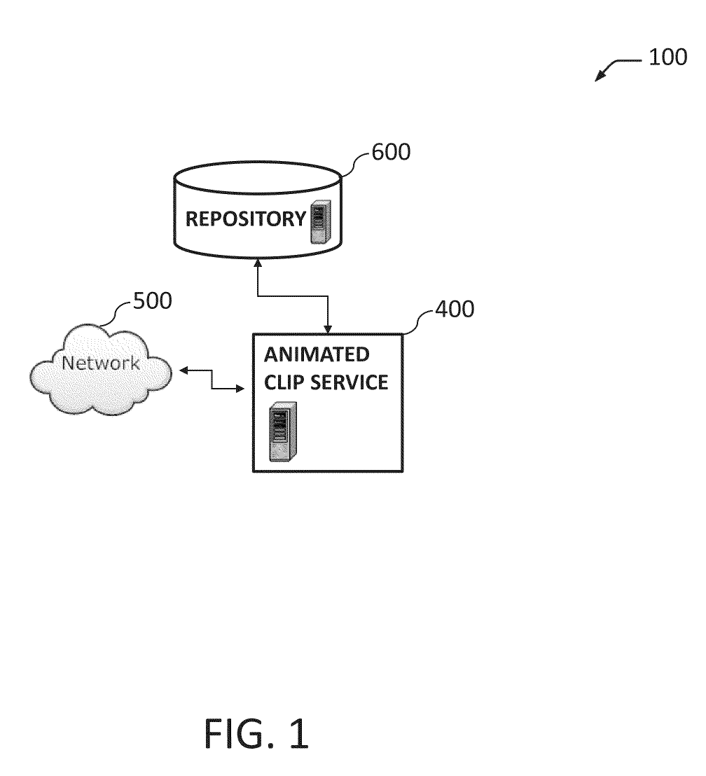

Referring now to FIG. 1, which is a high-level block diagram of a communications system 100 that manages a messaging experience by matching multimedia objects to intention indications of parties of a visual session, according to some embodiments of the present invention. During a visual session, each party responds to automatically selected multimedia object(s), such as video clips, with input(s) that introduce other automatically selected multimedia object(s) into the visual session. In such a manner, the visual session may iteratively form a mosaic of multimedia objects, through successive addition of, for example, video clips.

The communications system 100 includes an animated clip service 400 running on a central unit, such as server computer having memory and a processor, a network 500 and a repository 600 running on a server computer.

As used herein, the terms database and/or repository refer to a collection of records, entries or data that is stored in a system and relies on software and/or hardware to organize the storage and retrieval of that data.

The animated clip service 400 is communicably coupled to one or more repositories 600 and is communicably connected to a network 500 via a network interface.

As used herein, the term service refers to any computerized component, network node or entity adapted to provide communications protocols and/or applications and/or content and/or other services to one or more client terminals, other devices or entities on a network or a remote network node.

As used herein, the term network refers generally to any type of telecommunications or data network including, without limitation, hybrid fiber coax (HFC) networks, satellite networks, telecommunications networks, and data networks including local area networks (LANs), metropolitan area networks (MANs), local area networks (LANs) and/or wide area networks (WANs), the Internet, and intranets.

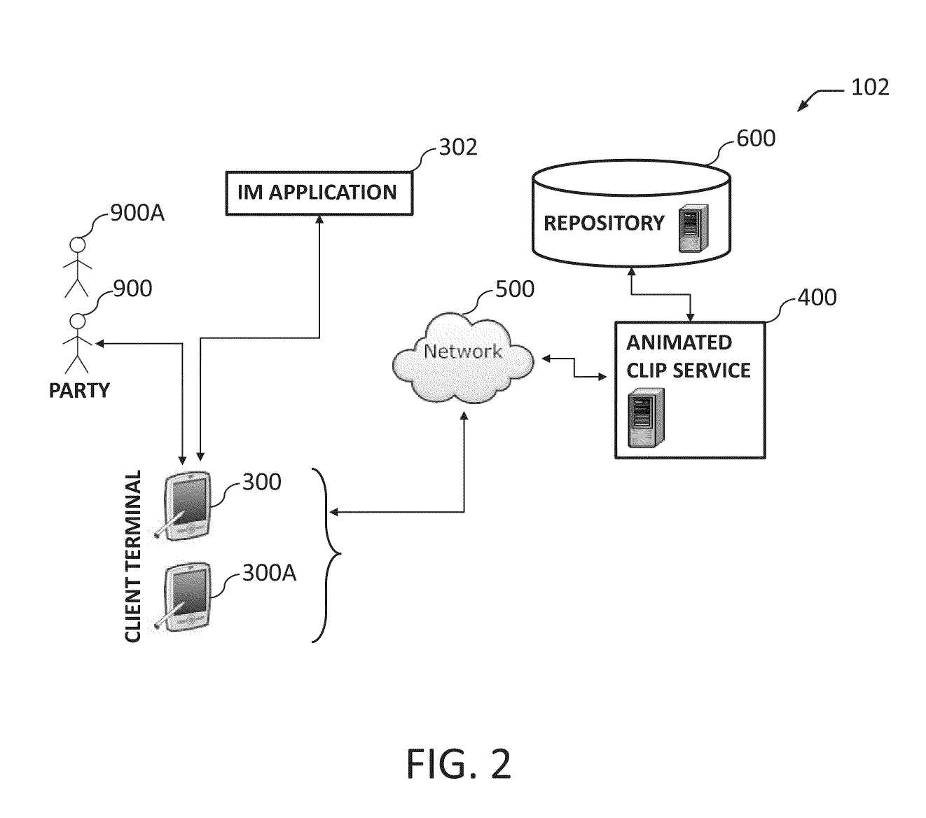

Referring now to FIG. 2, which is a high-level block diagram of a communications system 102, according to some embodiments of the present invention. Communications system 102 may include an IM application 302 executed on a client terminal 300 for engaging a first party with a plurality of parties 900 in a visual session, according to some embodiments of the present invention.

A party may access the animated clip service 400 using the client terminal 300 by connecting to the animated clip service 400 via network 500. As illustrated in FIG. 2, a plurality of parties 900 and 900A are communicably coupled to the network 500 via client terminals, 300 and 300A, respectively.

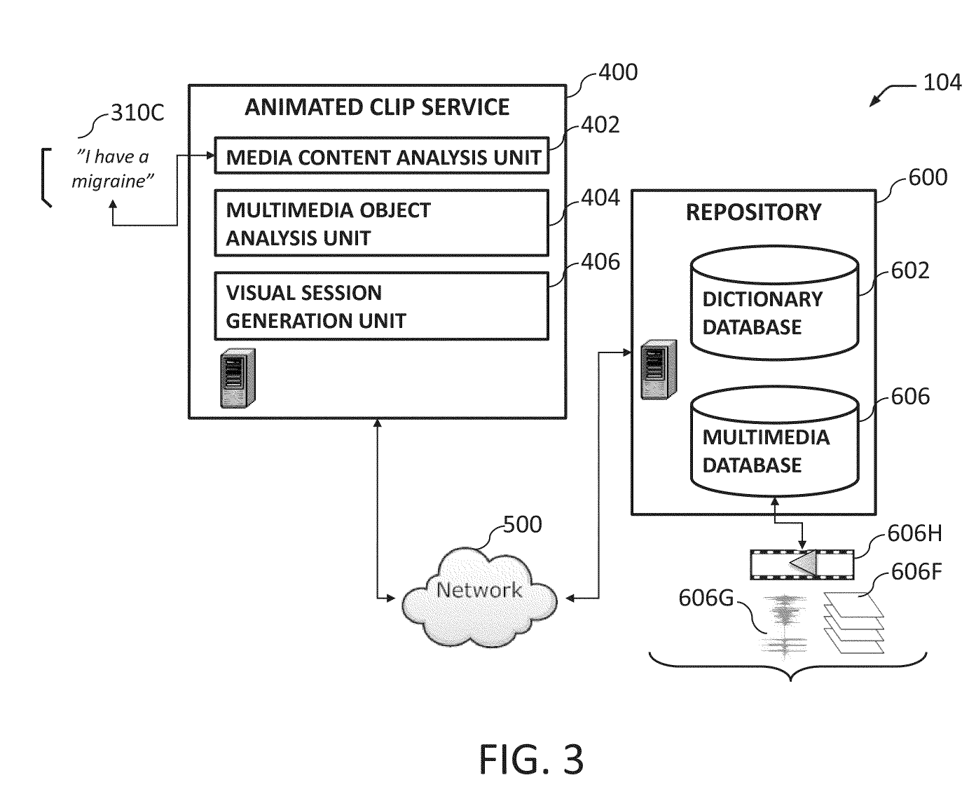

Referring now to FIG. 3, which is a detailed block diagram of a communications system 104, according to some embodiments of the present invention.

The one or more repositories 600 provide to the animated clip service 400, via a multimedia object database 606, access to one or more multimedia objects. Each of the multimedia objects may be associated with one or more meta-data attributes such as a category, type a set of contextual tags and/or the like. The animated clip service 400 may query the multimedia object database 606, to search for multimedia objects matching a set of conditions having, for instance, a specific set of meta-data attributes. For instance, searching for a multimedia object that has a category meta-data attribute equating to children books, or a type meta-data attribute equating to sprite animation. Or, for instance, searching for a multimedia object such as an instructional video for children having type video and falling under the children's' category which is associated with one or more of the following contextual tags: child, animation, children, and kindergarten.

The one or more repositories 600 may store a dictionary database 602 utilized for the retrieval of word and/or morpheme synonyms and antonyms, temperament, moods, emotional states and/or the like.

Optionally, the system may utilize background processing and analysis of multimedia objects. As used herein, the term background processing refers to performing a data processing operation, such as analyzing the content of an object in a multimedia database, in the background.

For instance, each introduction of a new multimedia object (not shown) into the multimedia object database 606, by, for instance, a system administrator, may trigger an automatic background processing of the object by a multimedia object analysis unit 404 described in detail hereinafter. When a multimedia object is subject to background processing, meta-data attributes pertaining to the multimedia object are collected in the background and stored in the multimedia object database 606. Thus, when the animated clip service queries the multimedia object database 606 in real-time to search and obtain the meta-data attributes associated with the background processed multimedia object, multimedia object database 606 access time may be shortened. This is since the multimedia object need not be analyzed again once information pertaining to the multimedia object preexists as a result of the background processing.

The animated clip service 400 includes the media content analysis unit 402 that analyzes and processes intention indications such as the exemplary text 310C, in order to extract corresponding relevant information. Based on the information extracted, the media content analysis unit 402, subsequently selects corresponding multimedia objects, such as the exemplary video clip 606H and/or the exemplary animated image set 606F and/or the exemplary animated audio 606G from the multimedia object database 606.

To illustrate, in some embodiments of the present invention, the media content analysis unit 402 analyses intention indications in the visual session, and a multimedia object analysis unit 404 selects multimedia objects that are analogous in terms of subject matter to the subject matter of some or all of the intention indications.

In some embodiments of the present invention, in case the intention indication is an exemplary intention indication 310B, reading “I love dogs” the content analysis unit 402 detects a subject (in this particular case, an animal) in the exemplary intention indication 310B, and the multimedia object analysis unit 404 selects multimedia objects that are related to that object (a dog for instance), for instance, a video illustrating the life of pet dogs. These are just two exemplary illustrations of how content analysis unit 402 and the multimedia object analysis unit 404 is adapted to select multimedia objects from multimedia object database 606 based on analyses of intention indications.

In yet another exemplary case, media content analysis unit 402 conducts textual analysis on intention indications; the results include one or more meta-data attributes for each intention indication. In like manner, the media content analysis unit 402 generates associations between the results of the abovementioned textual analysis (e.g. or more meta-data attributes), and lists of meta-data attributes associated with the multimedia objects stored in the multimedia object database 606. Utilizing such associations may aid in identifying and matching more closely multimedia objects baring similar context to intention indications.

Optionally, the content analysis unit 402 and/or the IM application 302 interactively suggest a party, in response to typing on a client terminal, text comprising one or more words, one or more morphemes and/or one or more incomplete sentences that completes the text typed by the party. The text auto completion suggestion(s) may be based on analyzing text entered and/or graphical symbols selected by the party. The text auto completion suggestion(s) may be retrieved from a list of tags or candidate keywords that are associated with each of the multimedia objects stored in the multimedia object database 606. For instance, if a party starts typing text reading “The pla” then the text auto completion suggestion(s) are (i) “The planet of the apes”, (ii) “The place” and (iii) “The planet”. Each of the suggestion(s) (i), (ii) and (iii) may be a tag associated with one or more of the multimedia objects stored in the multimedia object database 606. For instance, both (i) and (iii) are tags associated with the multimedia object “the planet of the apes”.

The auto completion may take place at the moment the party starts typing a message, during any of the stages while the party and/or recipients are still typing and/or when either party finishes typing his message. The suggested text is presented to the party on a client terminal and the text becomes selectable, for example clickable or touchable. At his discretion, the party may select the textual segment(s) and the IM application 302 in response substitutes the textual segment(s) with the user selected segment(s).

In yet another exemplary case, the dictionary database 602 is utilized in the textual analysis conducted by the content analysis unit 402. For instance, to query one or more predetermined phonemes, phrases of temperament, moods and/or emotional states stored in the dictionary which have context similar to context found in intention indications. To further illustrate an exemplary scenario, while two parties are conversing and one party types the exemplary text 310C “I have a migraine”, textual analysis utilizing the dictionary database 602 may result in the following list of one or more meta-data attributes: human, head, migraine, medicine.

It is to be understood that the textual methods may be accomplished using techniques known in the arts. For instance, text segmentation which may be used in the analysis may be implemented using machine learning algorithms and/or probabilistic techniques such as the hidden Markov model (HMM) and the like.

Optionally, the communications system 102 includes a speech to text (STT) unit (not shown) that background processes multimedia objects. For instance, a video having an audio/speech track is analyzed in the multimedia object database 606, speech associated with the video is extracted, spoken language(s), voice(s) and/or background sound(s) are extracted, subsequently generating human readable text, corresponding to one or more extracted speech segments of the video. The human readable text may be stored in the multimedia object database 606 and may be utilized by the animated clip service 400 as part of querying the multimedia object database 606 to search for content having similar context to the content found in the human readable text.

Communications system 104 includes a visual session generation unit 406 utilized in conjunction with the abovementioned units in order to manage and generate a visual session.

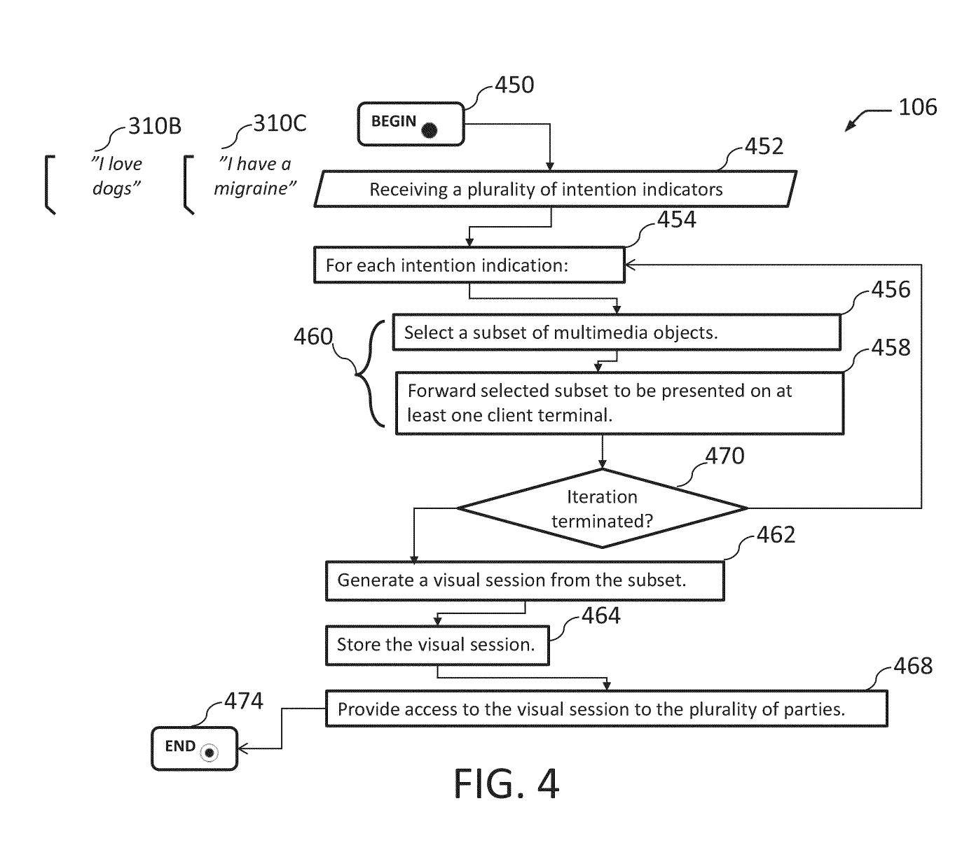

Referring now to FIG. 4, which illustrates a method 106 for generating and managing a visual session, according to some embodiments of the present invention.

First, the method begins at 450 followed by receiving, at 452 from a plurality of client terminals 300 of a plurality of parties participating in a visual session, a plurality of intention indications such as the exemplary intention indication 310B and exemplary intention indication 310C.

Next, at 454 for each of the plurality of the intention indications received, the method loops and performs at least the following:

I. Selects at 456 one or more of multimedia objects from a multimedia objects database 606.
II. Forwards at 458 to the animated clip service 400 the selected one or more of multimedia objects to be presented on at least one client terminal from the plurality of client terminals of at least one party of the plurality of parties.
III. Next at 470 the result of a true/false test is evaluated to determine whether the exemplary intention indications 310C and 310B are all iterated through.
IV. In case they are not (e.g. the result of the test is false), the method continues at 454 until all the plurality of intention indications are iterated through.

In case the plurality of exemplary intention indications 310C and 310B are all iterated through (e.g. result of the test is true), then:

I. Generates at 462 the visual session from the one or more of selected multimedia objects.
II. Next, at 464 stores the visual session.
III. Next, at 466 the method provides access to the visual session to the plurality of parties from the plurality of client terminals.

Finally, the method terminates at 472, once all the exemplary intention indications 310C and 310B are iterated through and access to the visual session is provided to the plurality of parties from the plurality of client terminals.

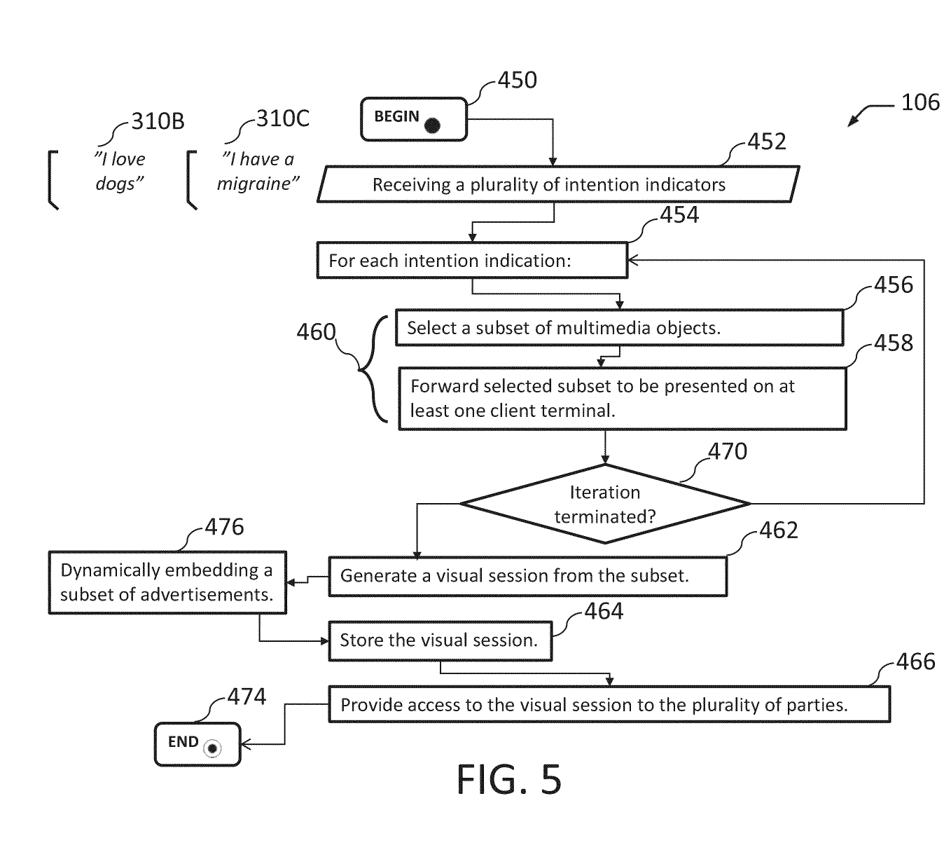

Referring also to FIG. 5, which is flowchart illustrating a method 108 for associating promotional content, according to some embodiments of the present invention. The method includes at 474, dynamic embedding of one or more advertisements. The advertisements may be selected from a plurality of candidate advertisements (not shown) into a plurality of segments in the visual session.

In some embodiments of the present invention there are provided several possible revenue models (not shown). For instance, the textual analysis of the intention indications and the processing by the animated clip service may facilitate identifying categories of promotional content based on related commercial features found in the textual analysis.

Optionally, and as exemplified, in FIG. 5 at 476, contextually related promotional content such as advertisements is embedded into one or more of the animated clips. Optionally, the system includes one or more repositories having entries representing one or more resellers (not shown) interested in promoting their products via one or more advertisements. Subsequently, resellers providing the promotional content may profit from receiving revenue generated as a result of a party purchasing one or more of the vendor's products. Each advertisement, such as for instance, an ad for a theater act, has one or more meta-data attributes associated with it. The meta-data attributes may be utilized to select related promotional content to be embedded into an animated clip, based on a match with the results of intended indication analysis.

It should be noted however that those skilled in the art will appreciate that the actual video content of the presented visual session may vary considerably across implementations, depending on the analysis of intention indications.

To illustrate, in some embodiments of the present invention, the visual session is a multimedia mosaic, such as a sprite animation, or an animated audio clip. In some other embodiments of the present invention the visual session comprise a union of animated hyperlinks and/or an animation of a transcript of events being heard in a social network video game. The visual session may comprise of overlaying text, hyperlinks, graphics and/or the like onto a video clip.

In some other embodiments of the present invention, the visual session is an animation of a series of highlighted words being selectable to display promotional content (e.g., by clicking on the highlighted word on the animated video the user is directed to a corresponding promotional content).

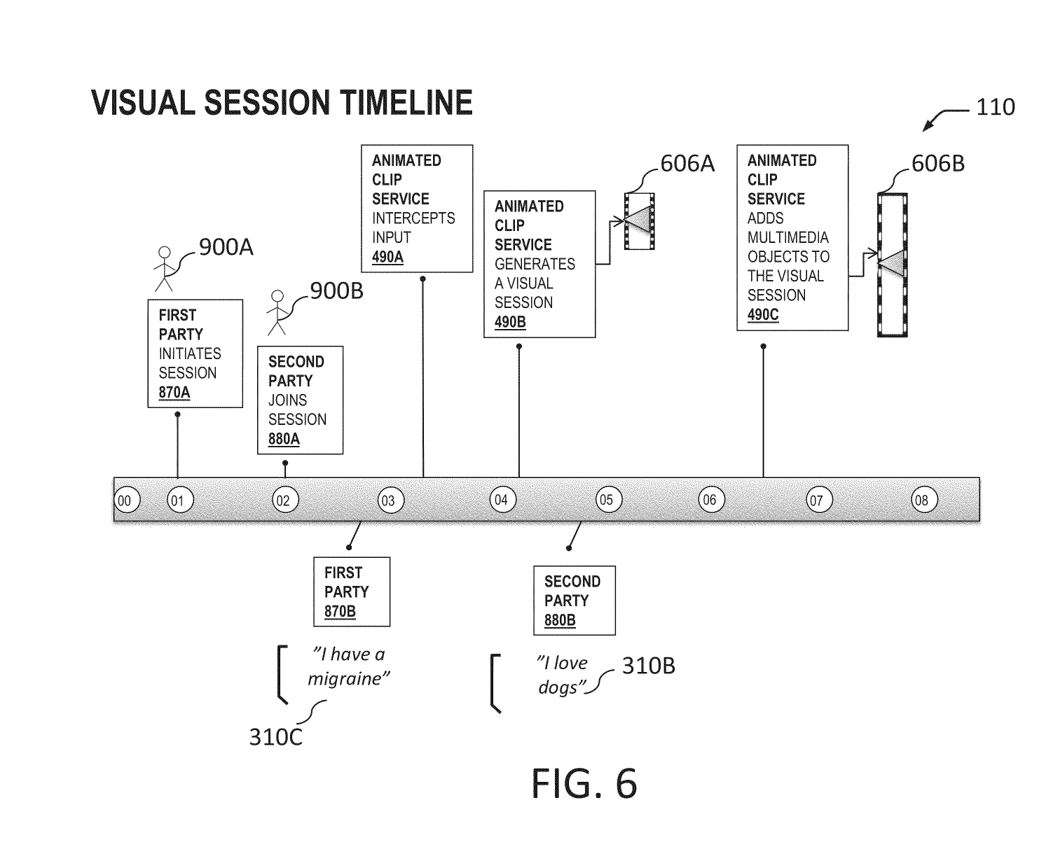

Referring now to FIG. 6, which illustrates the time-lagged sequence of events 110 occurring during a visual session between a plurality of parties, according to some embodiments of the present invention.

A first party 900A and second party 900B events are depicted by numerals 870 and 880 respectively, and animated clip service 400 events are depicted by numeral 490.

When a first party 900A communicates with a second party 900B (e.g., using a client terminal), both parties may establish a visual session. In establishing the session, each party may delegate intention indications to the other party through the animated clip service, indications that may be analyzed and processed by the animated clip service before being forwarded to the parties' client terminals.

Furthermore, an IM application, such as the one depicted by numeral 302 of FIG. 2 may be further adapted to initiate multiple sessions from a single terminal with multiple other client terminals, and concurrently receive and transmit processed intention indications from multiple parties' client terminals.

For example, assume that the first party 900A wishes to establish a visual session with the second party 900B, and also sends additional information to the animated clip service 400 indicating that he is a fan of comedies. In such an instance, the animated clip service 400 may utilize this information to analyze the intention indications sent by the first party, in light of the known additional information (e.g. comedies) about the first party 900A.

Reference is now made to the sequence of events of FIG. 6. The first party 900A communicates with a second party 900B at 870A. The second party 900B communicates back with the first party 900A at 880A. It should be noted that the sequence of events is exemplary illustrating only two parties; however, according to some embodiments of the present invention more than two parties may engage in a visual session.

Continuing at 870B, the first party 900A delegates the exemplary text 310C reading “I have a migraine”, next at 490A the animated clip service 400 intercepts the exemplary text 310C analyzing the intention indications and at 490B, generates a visual session 606A. It is noted, that a party first delegates his inputted text or message to the animated clip service 400, which may process the message and only then, is the processed message (e.g. now a multimedia object) being delegated to the designated plurality of parties.

Having information that the party is, for instance, a fan of comedies, the animated clip service 400 manages a visual session that is contextually related to both the migraine the party is suffering from and the comedy film category that the party is a fan of.

For instance, in some embodiments of the present invention the generated visual session 606A may be an animated clip of someone holding his head in his hands, in order to convey the fact the party is suffering from a migraine. In some other embodiments of the present invention the generated visual session 606A may be an animated clip of someone wearing headphones while listening to soothing music.

As noted above, both parties party 900A and party 900B are required to provide input before being provided access to the generated visual session 606A (the actual providing is not shown in the series of events). Subsequently, each party may respond to the animated clip being displayed to him on his client terminal as illustrated at 490B-1. In the exemplary illustration, the second party 900B delegates the exemplary intention indication 310B.

Next at 490C, the animated clip service 400 intercepts the exemplary intention indication 310C analyzing the intention indications and at 490C, adding multimedia objects retrieved from the multimedia object database 606 to the visual session 606A. The selection of the actual multimedia objects comprising the visual session, possibly a mosaic, may be based now on one or more of the intention indications used by the parties, e.g. 310C and 310B, and any other data such as meta-data attributes associated with the multimedia objects.

Once the parties access (not shown) the generated visual session, 606A they may continue partaking in the visual session and other parties may join the session as well or initiate separate exclusive sessions with each of the parties.

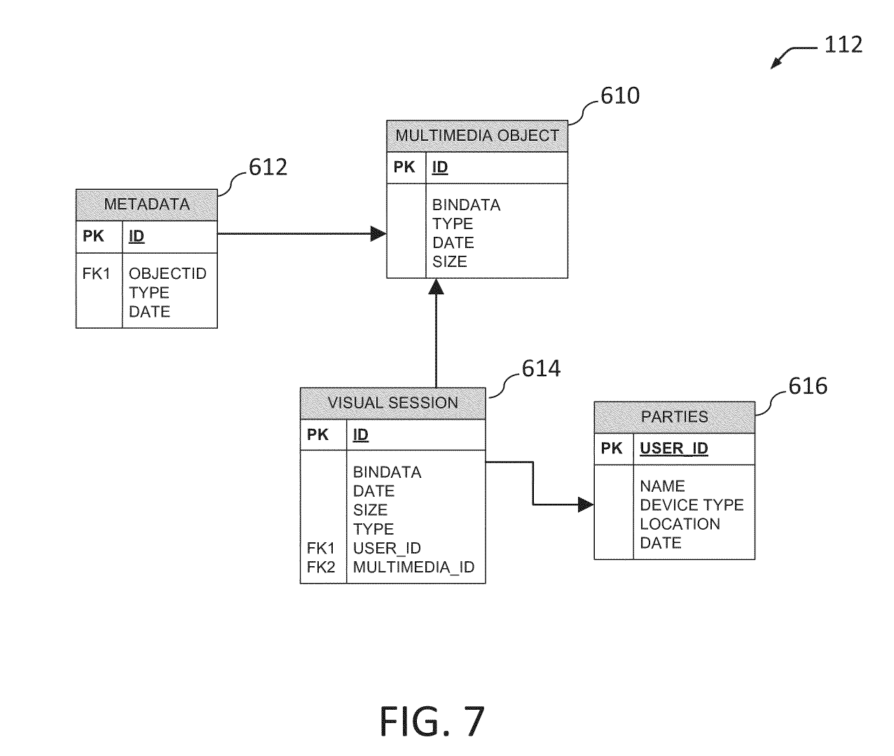

Reference is now made to FIGS. 1, 7. FIG. 7 illustrates an exemplary entity relationship diagram (ERD) 112 of a multimedia object database managed by the animated clip service, according to some embodiments of the present invention.

As used herein, the term ERD refers to graphs depicting the links between tables in a relational database.

The multimedia object database 606 is used for storing and retrieving entries employed by the animated clip service 400. It should be noted however, that in some embodiments of the present invention, several databases are used rather than a single database. Back to FIG. 7, table 610 stores multimedia objects, table 612 stores meta-data attributes pertaining to the multimedia objects, table 614 stores generated visual sessions and table 616 stores information pertaining to the parties partaking in a visual session.

In some embodiments of the present invention, the tables, their attributes and the relationships between the tables are configured as follows:

I. Table 610 is utilized to describe and store multimedia objects and may comprise of the following attributes: an ID used as a unique primary key to differentiate between table rows, a BINDATA used as a binary container for the actual multimedia objects, a TYPE indicating the type of the multimedia object, a DATE indicating when was the multimedia object created and a SIZE indicating the size, in mega-bytes, of the multimedia object.
II. Table 612 is utilized to describe and store meta-data attributes pertaining to multimedia objects and may comprise of the following attributes: an ID used as a unique primary key to differentiate between table rows, a METADATA used as a container for the actual multimedia objects meta-data attributes, a TYPE indicating the type of the meta-data attributes, a DATE indicating when was the meta-data attributes created and a OBJECTID used as a foreign key to link table 610 in a many-to-one relationship with table 612.
III. Table 614 is utilized to describe and store visual sessions and may comprise of the following attributes: an ID used as a unique primary key to differentiate between table rows, a BINDATA used as a binary container for the actual multimedia visual session, a TYPE indicating the type of visual session, a DATE indicating when was the visual session created and a SIZE indicating the size, in mega-bytes, of the visual session, a USER_ID used as a foreign key to link table 610 in a many-to-one relationship with table 616 and a MULTIMEDIA_ID used as a foreign key to link table 610 in a many-to-one relationship with table 614.
IV. Table 616 is utilized to describe and store information about parties and may comprise of the following attributes: a USER_ID used as a unique primary key to differentiate between table rows, a NAME used as the name of the party, a DEVICE TYPE indicating the type of the client terminal the party is using, a DATE indicating when the user started a visual session and a LOCATION indicating the geo localized location of the party.

It should be noted that when the animated clip service 400 queries the multimedia object database 606, it may utilize information stored in one or more of the tables described hereinabove in order to find suitable multimedia objects that best reflect the intention indications that the animated clip service 400 processes.

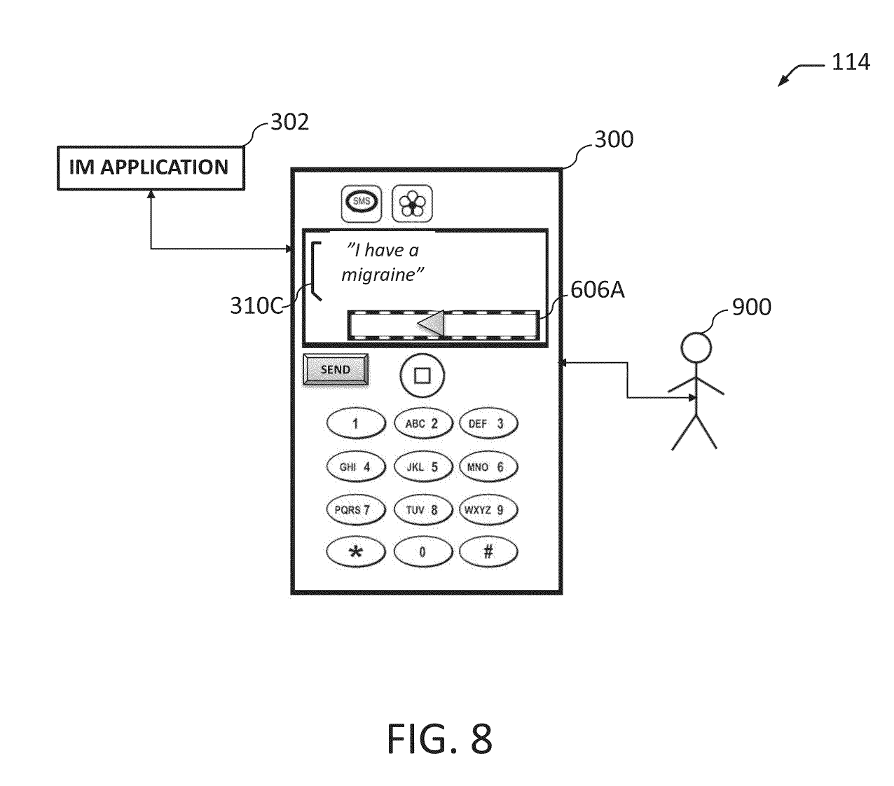

Referring now also to FIG. 8, which is a diagram of an exemplary graphical user interface (GUI) 114 of a visual messaging application, according to some embodiments of the present invention.

The client terminal 300 may be installed with the IM application 302. The IM application 302 may communicate with the animated clip service 400 via a network 500. In order for a client terminal 300 to receive and transmit information from and/or to the animated clip service 400 via the network 500, it has an embedded network communications module such as wireless module known in the art.

The IM application 302 may be installed on the client terminal before the client terminal is purchased and/or after the client terminal was acquired or may be embedded into the client terminal. Optionally, the IM application 302 may be offered to the user either free of charge, at a discounted or subsidized rate, or some combination thereof.

Client terminal 300 includes a processor and memory (not shown) and may include a plurality of applications such as, for instance the aforementioned IM application. The IM application, which may initiate presentation of the GUI on the client terminal, may be logic implemented in any combination of hardware and software, may be stored in memory and run by a processor and used to accept input entered by party and display information such as a visual session.

The application's GUI may have a first area displaying one or more graphical symbols selected from a palette of graphical symbols, a second area displaying one or more inputs entered by the party, a third area displaying a button which when clicked, delegates input entered by the party and selectable graphical symbols to the animated clip service and a forth area displaying a visual session. The graphical symbols may be selected by a party from the palette of graphical symbols which is presented on the client terminal.

The graphical symbols selected by a party, may be also utilized as intention indications in the same manner that party provided textual input is analyzed by the animated clip service of FIG. 1. For instance, a graphical symbol, such as an emoticon selected by a party, may be analyzed to detect emotions and idioms the party intended to convey. The emotions and idioms are used in the selection of multimedia objects by searching for multimedia objects having context similar in nature to the context of the emotions and idioms.

The IM application may run on the client terminal when selected by a party. The application may also be used to receive content and other information related to the location of the client terminal and to provide this content to other modules or to the animated clip service 400.

As shown in FIG. 8, the party 900 may interact with the client terminal 300 and initiate a session with another party and type the exemplary text 310C reading “I have a migraine”. The exemplary text 310C is subsequently analyzed by the animated clip service as described in detail hereinabove and then the parties are given access to the visual session 606A generated by the animated clip service.

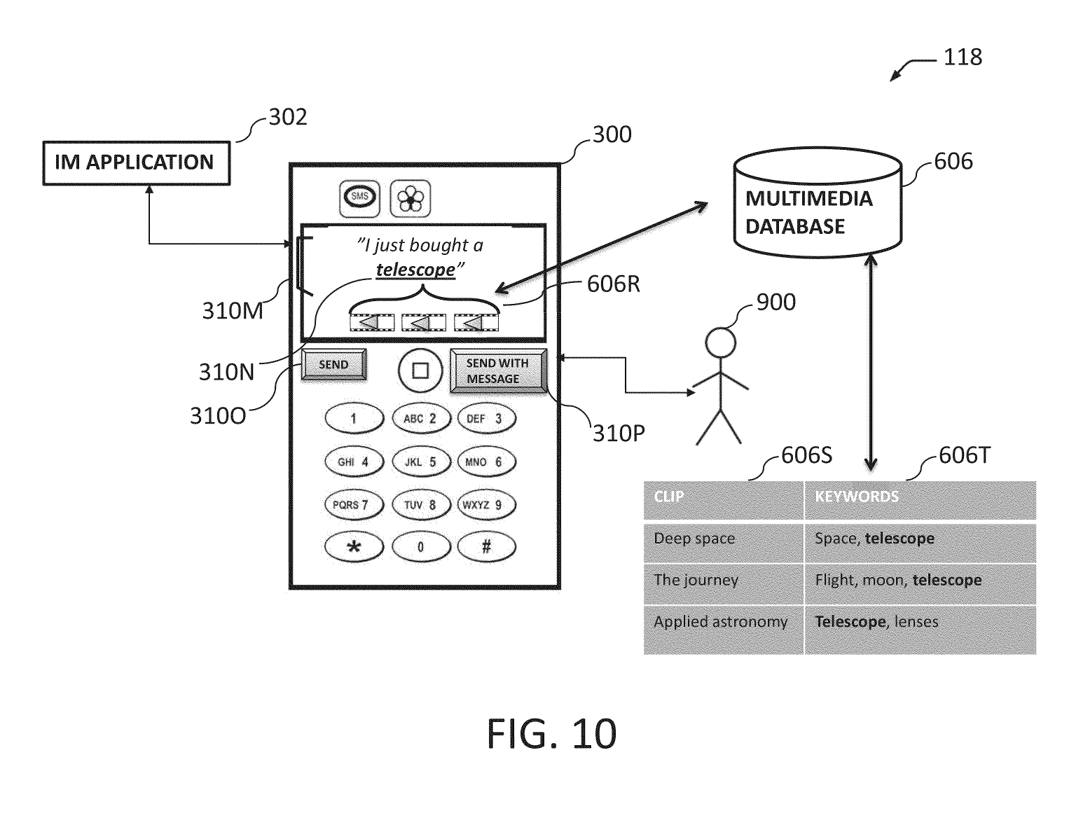

Reference is now made to FIG. 10 which is schematic illustration of method of dynamically suggesting multimedia objects to a party, from the perspective of a party, according to some embodiments of the present invention.

The IM application 300 automatically associates one or more multimedia objects 606R for one or more keywords 310M found in party provided text 310M while the party is typing. Subsequently, the one or more multimedia objects 606R are represented as icons on a display of the client terminal of a party for selection by the party.

First the party 900, using a message editor 302, for example IM or messaging applications, on the client terminal 300, provides textual content 310M, for instance, reading “I just bought a telescope”.

Next, one or more keywords 310N in the textual content 310M provided by the user is identified, for instance the keyword reading “telescope”.

Subsequently, the message editor, using the IM application 320, provides access to a database 606 comprising a plurality of multimedia objects 606S each associated with one or more of a plurality of candidate keywords 606T.

Afterwards, a query determines whether there is a match between the one or more keywords 310N and the plurality of candidate keywords 606T,

Next, if there is a match, one or more icons are presented to the party. The one or more icons represent at least one multimedia object 606R from the list of multimedia objects 606S.

It should be noted the selection of the one or more multimedia objects 606R is done according to the abovementioned match.

Finally, in response to a party selection of one or more icons, the one or more multimedia objects 606R are transmitted to one or more recipients, for example recipient(s) partaking in a communication session with the selecting party 900.

It should be understood that, the original text typed by the party 900 may or may not be transmitted to the one or more recipients with the one or more multimedia objects 606R. In addition, the party 900 may decide to:

I. By clicking on the send button 3100, transmit only the one or more multimedia objects 606R.
II. By clicking on the send with message button 310P, transmit both the one or more multimedia objects 606R and the original text typed by the party 900.

It is to be understood that the one or more multimedia objects 606R may be suggested simultaneously and that one or more multimedia objects 606R may be suggested for the same and/or different keyword.

### EXAMPLES

Reference is now made to the following examples, which together with the above descriptions illustrate some embodiments of the invention in a non-limiting fashion.

### Example I

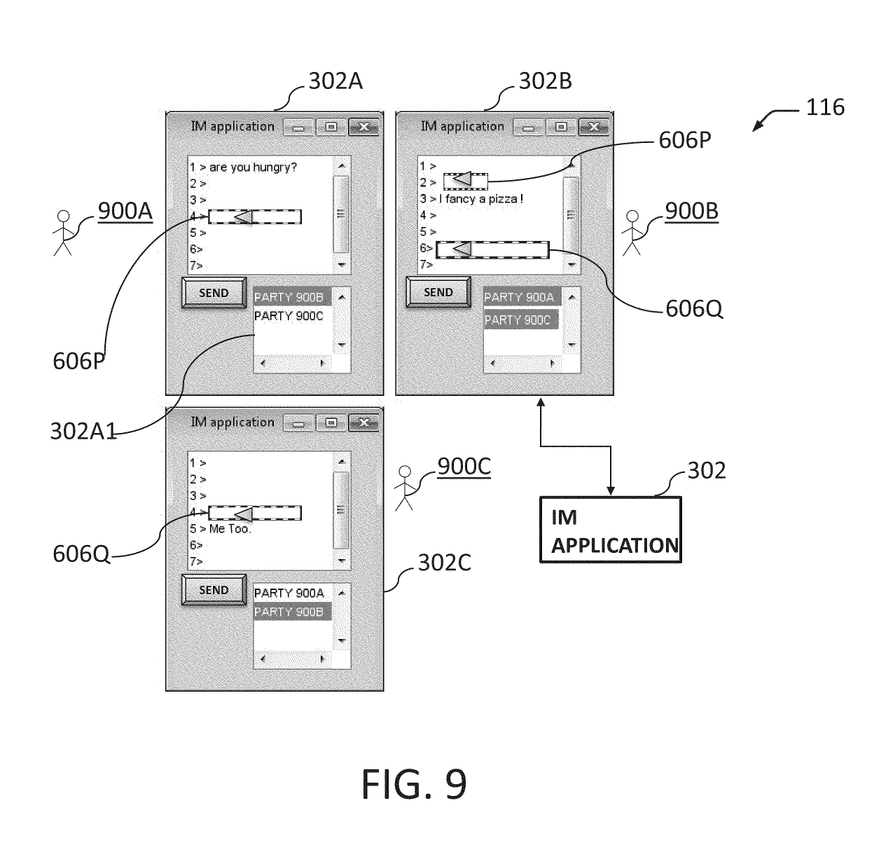

Referring now to FIGS. 2 and 9. FIG. 9 is an illustration, describing from the perspective of a plurality of parties, an exemplary generation of multiple visual sessions with multiple parties, according to some embodiments of the present invention. If broken down into individual stages, the exemplary generation process may progress as follows.

At the beginning, the first party 900A using IM application 302A indirectly engages with one or more parties through the animated clip service. Party 900A, chooses, from the online friends list 302A1, to communicate with party 900B, who is using IM application 302B.

Next, the first party 900A inputs text reading “are you hungry?” and by actuating the “send” button, delegates the text to the animated clip service 400 which analyses the text for detecting intention indications.

The animated clip service 400 communicates with the multimedia object database and, based on the analysis of “are you hungry?”, queries the multimedia object database 606 to retrieve and select one or more multimedia objects such as 606H, 606F and/or 606G. The multimedia objects selected are associated with the visual session 606P, to which the animated clip service 400 allows access to, from the IM application 302B of the second party 900B. The visual session 606P may be an animated clip of someone eating, or a specific food, to convey the fact the first party 900A is hungry.

Next, in response to viewing the visual session 606P, the second party 900B inputs text reading “I fancy a pizza” and by clicking the send button, delegates the text to the animated clip service 400 which again analyses the text for detecting intention indications and for the selection of multimedia objects. However, the second party 900B communicates also with a third party 900C, as depicted in his friends list. The animated clip service 400, which already manages the visual session 606P, after analyzing the text reading “I fancy a pizza”, generates a visual session 606Q between the second party 900B and the third party 900C. The multimedia objects selected by the animated clip service for each of the visual sessions 606P and 606Q need not be the same; the parties, party 900A and party 900C, may receive different video content (e.g. animated clip), even though the second party 900B delegated the same text “I fancy a pizza” through the animated clip service 400 to both of them. This illustrates, that under some embodiments of the present invention, multiple concurrent visual sessions such as visual session 606P and visual session 606Q, different in video content, are managed simultaneously by the animated clip service 400.

Then, the third party 900C also inputs text reading “me too”, in response to being provided access to the visual session 606Q that may be an animated clip of someone eating pizza and milkshake. Then the textual analysis by the animated clip service 400 repeats and, in this specific example, the animated clip service 400 provides access to the visual session 606Q comprising one or more of the retrieved multimedia objects only to the second party 900B and not to the first party 900A.

The cycle described above may continue until the first party and/or the one or more of the other parties terminate the visual session.

In practice the cycle of described may follow several permutations such as either a first party or the one or more parties continue to partake in the visual session and provide input, thus resulting in concurrent visual sessions with multiple parties as illustrated hereinabove.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant animated clip generation system will be developed and the scope of the term animated clip generation system is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of managing a visual session using a plurality of multimedia objects, in a computerized system, comprising:
receiving, using a processor, a plurality of intention indications from a plurality of client terminals of a plurality of parties participating in said visual session;
for each said plurality of intention indications:
selecting at least one multimedia object from a database of said plurality of multimedia objects;
forwarding said at least one multimedia object to be presented on at least one of said plurality of client terminals;
generating said visual session from said at least one of multimedia object;
storing said visual session; and
providing an access to said visual session to said plurality of parties from said plurality of client terminals.

2. The method of claim 1, wherein said plurality of intention indications comprise a plurality of text segments, each of said plurality of text segments is extracted from a text messaging interface which is presented on one of said plurality of client terminals to one of said plurality of parties.

3. The method of claim 1, wherein said plurality of intention indications comprise a plurality of graphical symbols, each of said plurality of graphical symbols is selected from a palette of graphical symbols which is presented on one of said plurality of client terminals to one of said plurality of parties.

4. The method of claim 1, further comprising:
dynamically embedding, at least one of a plurality of candidate advertisements into a plurality of segments in said at least one multimedia object.

5. The method of claim 2, wherein said plurality of text segments are subject to content analysis, wherein said content analysis identifies a plurality of intention indications.

6. The method of claim 3, wherein said plurality of graphical symbols are subject to content analysis, wherein said content analysis identifies a plurality of intention indications.

7. The method of claim 5, wherein said content analysis includes at least one of semantic, morphological and syntactic analysis thereby generating a plurality of text classifications and a sequence of morphemes, said plurality of text classifications and said sequence of morphemes are used for identifying said plurality of intention indications.

8. The method of claim 6, wherein said content analysis includes at least one of image analysis and motion analysis thereby generating a plurality of image and motion classifications, said plurality of image and motion classifications used for identifying said plurality of intention indications.

9. A system for managing a visual session using a plurality of multimedia objects, comprising:
a network interface which receives a plurality of intention indications from a plurality of client terminals of a plurality of parties participating in a plurality of iterations of a visual session, each of said plurality of intention indications is received during another of said plurality of iterations;
a multimedia object database which stores a plurality of multimedia objects;
a processor; and
an animated clip service which uses said processor during each of said plurality of iterations to match at least one of said plurality of multimedia objects to one of said plurality of intention indications and to forward said at least one of said plurality of multimedia objects to be presented on at least one of said plurality of client terminals during said visual session.

10. The system of claim 9, wherein said animated clip service is configured to:
receive a message containing a plurality of intention indications from a plurality of client terminals of a plurality of parties across said network interface;
analyze said plurality of intention indications using a media content analysis unit;
select at least one multimedia object from a plurality of first entries in said multimedia object database using a multimedia object analysis unit; and
in response to said selecting, using a visual session generation unit to generate a respective visual session, thereby allowing each of a plurality of parties access to an application running on each of said client terminals, wherein said application causes a user interface to be displayed on a display of said plurality of client terminals in response to accessing said visual session.

11. The system of claim 10, wherein said multimedia object database is communicatively coupled to said animated clip service, wherein said multimedia object database storing said plurality of first entries denoting a plurality of multimedia objects, a plurality of second entries denoting a plurality of meta-data, a plurality of third entries denoting a plurality of visual sessions and a plurality of forth entries denoting a plurality of parties.

12. A method for displaying a visual session on a client terminal used by a party, said method comprising:
providing a party access to a visual session generated by an animated clip service;
initiating presentation of a graphical user interface (GUI) on said client terminal;
wherein said graphical user interface includes at least:
a first area displaying a palette comprising at least one selectable graphical symbol;
a second area displaying at least one text input;
a third area displaying a button which when clicked, delegates at least one of said at least one text input and said at least one selectable graphical symbol to said animated clip service; and
a forth area displaying said visual session.

13. The method of claim 12, further comprising:
simultaneously displaying information in said first area, said second area, said third area and said forth area of said graphical user interface.

14. A computer program product comprising a non-transitory computer usable storage medium having computer readable program code embodied in said medium for managing a visual session using a plurality of multimedia objects, said computer program product comprising:
first computer readable program code means for enabling a processor to receiving, from a plurality of client terminals of a plurality of parties participating in said visual session a plurality of intention indications;
for each said plurality of intention indications, second computer readable program code means for enabling a processor to:
selecting at least one multimedia object from a database of a plurality of multimedia objects;
forwarding said at least one multimedia object to be presented on at least one client terminal from said plurality of client terminals;
third computer readable program code means for enabling a processor to generating and managing a visual session from said at least one multimedia object;
forth computer readable program code means for enabling a processor to storing said visual session; and
fifth computer readable program code means for enabling a processor to providing an access to said visual session to said plurality of parties from said plurality of client terminals.

15. A computerized method of storing multimedia objects, in a computerized database system, said method comprising:
storing, using a processor, a plurality of first entries denoting a plurality of multimedia objects, a plurality of second entries denoting a plurality of meta-data attributes, a plurality of third entries denoting a plurality of visual sessions and a plurality of forth entries denoting a plurality of parties.

16. The computerized method of claim 15, further comprising:
receiving at least one intention indication identification;
retrieving a plurality of multimedia objects matching said at least one intention indication identification;
wherein each entry of said plurality of first entries comprises at least one of multimedia object identification, date, binary data, type, size;
wherein each entry of said plurality of second entries comprises at least one of meta-data identification, date, meta-data attributes, object identification;
wherein each entry of said plurality of third entries comprises at least one of visual session identification, date, binary data, type, size, user identification, multimedia identification; and
wherein each entry of said plurality of forth entries comprises at least one of party identification, name, location, device type, date.

17. A computerized method of dynamically suggesting multimedia objects in a client terminal of a party, comprising:
providing a database comprising a plurality of multimedia objects each associated with at least one of a plurality of candidate keywords;
receiving textual content of a message, said textual content is typed in a message editor by the party using the client terminal before said message is sent to at least one recipient;
identifying, using a processor, a match between at least one keyword in said textual content and a group from said plurality of candidate keywords, said group is associated with at least one of said plurality of multimedia objects;
presenting an indication representing said match on a graphical user interface of said message editor; and
selecting by said party to send said at least one associated animated video clip to said at least one recipient.

18. The computerized method of claim 17, further comprising transmitting said at least one animated multimedia object in response to said selection.

19. The computerized method of claim 17, wherein said indication comprises at least one selectable icon, said computerized method further comprising:
identifying a selection of said at least one selectable icon by said party; and
transmitting said at least one multimedia object in response to said party selection.
